(19) United States
(12) Patent Application Publication
(10) Pub. No.: US 2009/0252444 A1
(43) Pub. Date: Oct. 8, 2009

(54) ROLLER BEARING INCLUDING AT LEAST ONE INSTRUMENTED AREA IN DEFORMATION THAT IS DELIMITED AXIALLY

(75) Inventors: Christophe Duret, Quintal (FR); Sebastien Guillaume, Menthon-Saint-Bernard (FR)

Correspondence Address: BACHMAN & LAPOINTE, P.C., 900 CHAPEL STREET, SUITE 1201, NEW HAVEN, CT, 06510, US

(73) Assignee: SNR ROULEMENTS, Annecy (FR)

(21) Appl. No.: 12/417,756

(22) Filed: Apr. 3, 2009

(30) Foreign Application Priority Data
Apr. 3, 2008 (FR) 08 01855

(51) Int. Cl. F16C 41/04

(52) U.S. Cl. 384/448

(57) ABSTRACT

A roller bearing includes a fixed element and a rotating element. The roller bodies act as a support on the raceway of the fixed element by the intermediary of a contact surface (S_{C}). The fixed element includes a free surface which is deformable elastically by the forces induced by the passage of the roller bodies during the rotation of the rotating element. The surface has at least one instrumented area whereon is associated at least one pattern of a sensitive material. The said area is delimited axially between the surface (S₁) defined by revolution around the axis of the bearing of the straight line (D₁) passing through the center (Cᵣ) of a roller body deforming the surface and by the center (C_{S}) of the contact surface (S_{C}) of the roller body and the surface (S₂) defined by revolution around the axis of the bearing from the normal line (D₂) to the deformable surface that passes through the center (C_{S}) of the contact surface (S_{C}).

### BACKGROUND

1. Field of the Invention

The invention relates to a roller bearing including a fixed element and a rotating element each including at least one raceway between which at least one row of roller bodies is arranged in order to allow for the relative rotation of said elements around an axis.

In particular, the invention applies to automobile wheel bearings, the fixed ring of said bearing being intended to be attached to the chassis of the vehicle, the wheel being intended to be mounted rotatable by the intermediary of the rotating ring of said bearing, and two rows of balls being provided between said rings.

2. Prior Art

In many applications, in particular in relation with assistance and safety systems such as ABS or ESP, it is necessary to determine the forces that are applied during the movements of the vehicle at the interface between the wheel and the road whereon said wheel turns.

In particular, the determination of these forces can be realised by a measurement of the deformations of the fixed ring which are induced by the passage of the roller bodies. Indeed, the amplitude of these deformations is representative of the forces transmitted by the bearing. For that, in particular EP-1 176 409 provides to instrument areas of the fixed ring by associating on them at least one measuring gauge of said deformations, said gauge including at least one pattern of a sensitive material which is able to be deformed by delivering a signal that is representative of said deformations.

However, the measurement of the deformations carried out as such remains difficult to use, in particular due to their low variation in amplitude. Furthermore, the sensitivity of the measurement is also limited by the global deformations of the fixed element which are induced by factors other than the passage of the roller bodies. In particular, the temperature induces global deformations of the fixed element, around which the deformations induced by the passage of the roller bodies vary to a low degree.

The invention aims to perfect prior art by proposing in particular a roller bearing of which the fixed element has instrumented areas whereon the patterns of sensitive material are arranged in order to optimise their sensitivity relatively to the variations in amplitude of the deformations induced by the passage of the roller bodies.

To this effect, the invention proposes a roller bearing including a fixed element and a rotating element each including at least one raceway between which at least one row of roller bodies is arranged in order to allow for the relative rotation of said elements around an axis, the roller bodies being as a support on the raceway of the fixed element by the intermediary of a contact surface, the fixed element including a free surface which is deformable elastically by the forces induced by the passage of the roller bodies during the rotation of the rotating element, said surface having at least one instrumented area whereon is associated at least one pattern of a sensitive material which is able to be deformed by delivering a signal that is representative of said deformations, the instrumented area being delimited axially between:

the surface defined by revolution around the axis of the bearing of the straight line passing through the centre of a roller body deforming the surface and by the centre of the contact surface of said roller body; and

the surface defined by revolution around the axis of the bearing from the normal line to the deformable surface that passes through said centre of the contact surface.

### BRIEF DESCRIPTION OF THE DRAWINGS

Other objectives and advantages of the invention shall appear in the description that follows, made in reference to the appended figures, wherein:

FIG. 1 is a partial perspective view showing the disposition of a roller body in a raceway of a fixed element;

FIG. 2 is a partial perspective view of the fixed element according to FIG. 1, showing the surfaces of axial delimitation of an instrumented area;

FIG. 3 are representations of the fixed outer element of a roller bearing according to a first embodiment of the invention, respectively in perspective (FIG. 3a) and as a longitudinal section (FIG. 3b);

FIG. 4 are representations of the fixed outer element of a roller bearing according to a second embodiment of the invention, respectively in perspective (FIG. 4a) and as a longitudinal section (FIG. 4b).

### DETAILED DESCRIPTION OF THE PREFERRED EMBODIMENT(S)

In relation with these figures, an automobile wheel roller bearing is described hereinbelow including a fixed outer element 1 intended to be associated with the chassis of the vehicle, and a rotating inner element (not shown) whereon the wheel is intended to be mounted.

Each of the elements includes two sets of raceways 2 which are spaced axially and between which two rows of balls 3 are respectively arranged in order to allow for the relative rotation of said elements around an axis. However, the invention can relate to other types of roller bearings, as well as bearings for other automobile applications or other applications.

During the movement of the vehicle, the wheel turns on the road by inducing forces at their interface, said forces being transmitted to the chassis by the intermediary of the bearing. Consequently, the determination of these forces, in particular for supplying the assistance and safety systems of the vehicle, can be realised by estimating in time the components of the force torsor that is applied to the bearing.

In particular, during the rotation of the rotating element in the fixed element 1, the passage of balls 3 induces elastic deformations of the circumferential outer periphery of the fixed element 1, of which the measurement can be used in order to calculate the estimation of the components of the force torsor. Indeed, the passage of the roller bodies 3 induces a force on the periphery, which deforms it elastically periodically around an average value.

The outer periphery of the fixed element 1 is provided with a least one free surface 4 which is deformable elastically by the forces induced by the passage of the roller bodies 3 during the rotation of the rotating element. In the embodiments shown, four deformable surfaces 4 are equally distanced on the outer periphery of the fixed element 1, said surfaces forming a flat surface of which the normal line extends radially. These flat surfaces are arranged above each of the rows of roller bodies 3 in such a way as to be deformed elastically by each of them.

The deformable surface 4 has at least one instrumented area 5 whereon is associated at least one pattern (not shown) of a material able to be deformed by delivering a signal that is representative of said deformations. According to one embodiment, the bearing includes a gauge of measurement of the deformations, said gauge including one or several patterns based on resistive elements, in particular piezoresistive or magnetostrictive, which are arranged directly on the deformable surface 4 or on a support substrate which is associated for example by gluing on the deformable surface 4.

In particular, a gauge including a bar of patterns spaced on a substrate can be used to deliver a pseudo-sinusoidal time signal around an average value, said signal being a function of the deformations of the deformable surface 4. As such, the signal can be conditioned to use the pseudo-sinusoidal component which is representative of the amplitude of the deformations induced by the passage of the roller bodies 3. However, the invention is not limited to a particular realisation of gauges of measurement of the deformations.

In order to optimise the sensitivity of the pattern of sensitive material relatively to the deformations which are induced by the passage of the roller bodies 3, an axial delimitation of the instrumented area 5 is described hereinbelow whereon said pattern is associated. In particular, the association of the substrate of the gauge on the deformable surface 4 can then be realised in such a way as to place the pattern of sensitive material on the instrumented area 5.

The axial delimitation of an instrumented area 5 is realised in relation to the roller bodies 3 of the row that induces the deformations to be measured. Furthermore, at least two types of instrumented areas 5 can be delimited axially in relation to the roller bodies 3 of respectively one row, the patterns of sensitive materials being arranged on each type of instrumented areas 5 so that they deliver a signal that is representative of the deformations induced by the passage of the roller bodies 3 of a row. Indeed, due to the low amplitude of the deformations, the pattern is sensitive only to the deformations induced by the roller bodies 3 of the row in relation to which the corresponding instrumented area 5 has been delimited. FIG. 2 shows the delimitation of a type of instrumented area 5, the other type can be constructed analogously with a roller body 3 arranged in the other row.

In particular, the patterns of sensitive material of each type of instrumented areas 5 can be arranged on the same substrate, in particular when the instrumented areas 5 are delimited on the same deformable surface 4 which extends axially from one raceway 2 to the other.

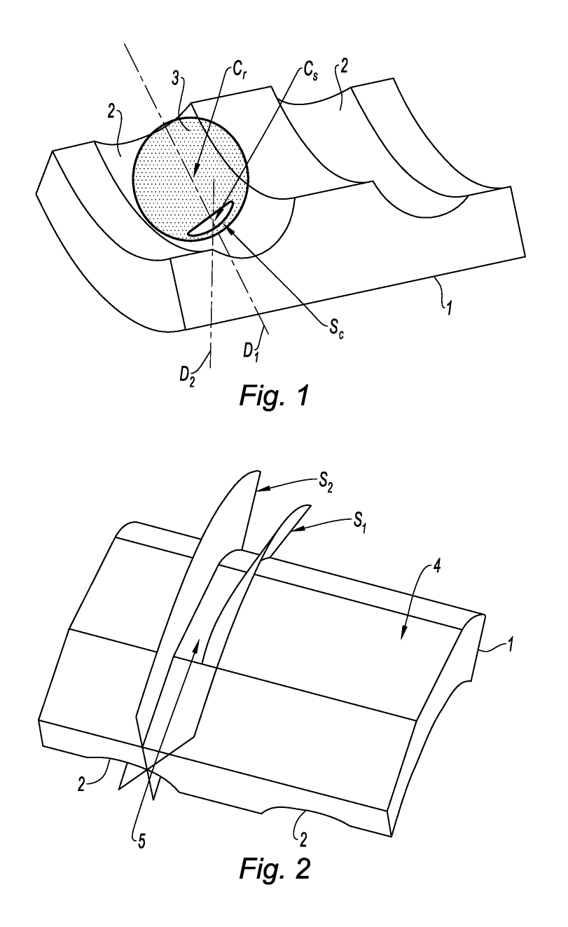

As shown in FIG. 1, the roller bodies 3 are as an oblique support surface on the raceway 2 of the fixed element 1 by the intermediary of a contact surface S_{C} which has a quasi-elliptic geometry in the case of a spherical roller body 3. In particular, the contact surface S_{C} is defined relatively to an oblique support surface of the roller body 3 in a determined load state of the bearing.

According to one embodiment, the determined load state corresponds to the pre-load state of the bearing. According to another embodiment, the determined load state corresponds to that wherein the bearing is the most often solicited and/or wherein it is sought to measure the deformations in a preferential manner or with the maximum accuracy.

As shown in FIG. 2, the instrumented area 5 is delimited axially between:

the surface S₁ defined by revolution around the axis of the bearing of the straight line D₁ passing through the centre Cᵣ of a roller body 3 deforming the surface 4 and by the centre C_{S} of the contact surface S_{C} of said roller body; and

the surface S2 defined by revolution around the axis of the bearing from the normal line D₂ to the deformable surface 4 that passes through said centre C_{S} of the contact surface S_{C}.

Furthermore, in order to improve the sensitivity of the pattern of sensitive material, the latter can be arranged precisely on the instrumented area 5. According to a first embodiment, the pattern of sensitive material can be arranged on the instrumented area 5 at the minimum of the thickness of the fixed element 1, said thickness being measured according to the normal line D₂ at said instrumented area. As such, the pattern of sensitive material is arranged as close as is possible to the roller bodies 3 in such a way as to measure deformations of maximal amplitude.

According to a second embodiment, the pattern of sensitive material can be arranged on the instrumented area 5 at the maximum of the rigidity of said instrumented area. As such, the pattern of sensitive material is arranged in such a way as to limit the influence of the variations of average deformation in the measurements. In particular, the relationship is as such increased between the variations of amplitude of the deformations induced by the passage of the roller bodies 3 and the average amplitude of the deformations of the fixed element 1. Indeed, the average deformations, in particular of out-of-roundness and of swelling of the outer periphery of the fixed element 1, are then limited on the pattern of sensitive material.

According to a third embodiment aiming to obtain a compromise between the advantages of the two preceding embodiments, the pattern of sensitive material can be arranged on the instrumented area 5 at the minimum of the relationship between the thickness of the fixed element 1 and the rigidity of said instrumented area.

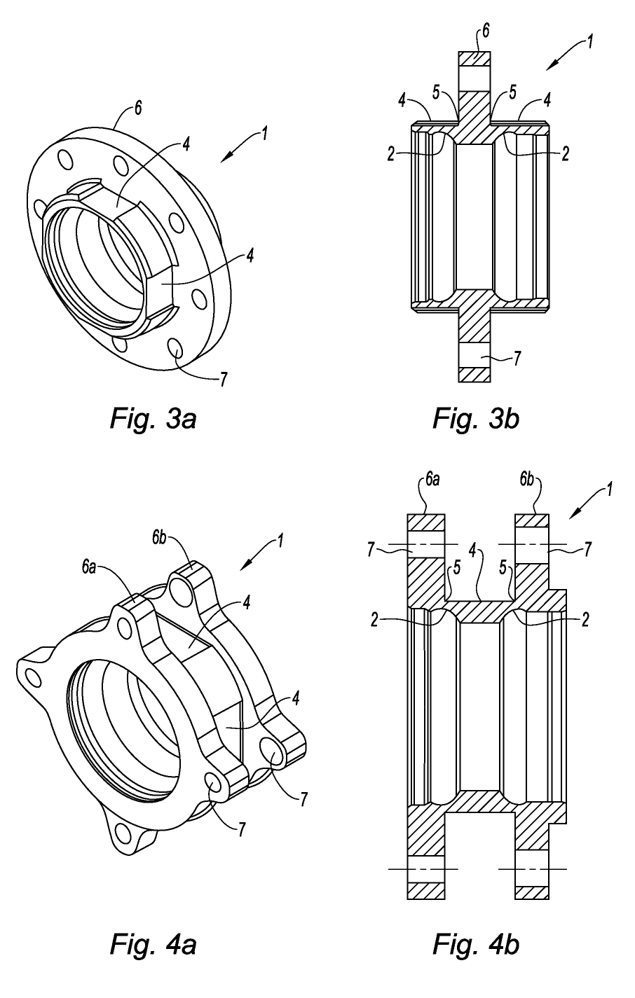

In relation with FIGS. 3 and 4, two embodiments are described hereinbelow of the fixed outer element 1 of a roller bearing wherein the outer periphery of said element has at least one clamp 6 including four orifices 7 forming means of fastening via bolting of the bearing to a fixed structure.

In particular, the clamp 6 extends substantially radially by being adjacent axially to at least one instrumented area 5 in such a way as to ensure rigidification of said area.

In the FIG. 3, a clamp 6 is formed between the rows of roller bodies 3 and a deformable surface 4 is formed as an axial extension of either side of said clamp. In this embodiment, the patterns of sensitive material of each type de instrumented areas 5 can be arranged axially in the vicinity respectively to a lateral face of the clamp 6.

In the FIG. 4, a clamp 6a, 6b is formed in the vicinity of each edge of the outer periphery and a deformable surface 4 extends axially between said clamps. As such, the types of instrumented areas can be rigidified by respectively a clamp 6a, 6b and the patterns of sensitive material of each type of instrumented areas 5 can be arranged axially in the vicinity of a lateral face of a clamp 6a, 6b.

Furthermore, in order to increase the differential rigidity between the instrumented area 5 and the rest of the periphery of the fixed element 1, the portion of the clamp 6 formed across from the non-instrumented area has a global height which is less than that of the portion of said clamp formed across from the instrumented area 5.

In the embodiments shown, the pattern of sensitive material can be arranged against the lateral face of the clamp 6, 6a, 6b, as close to the latter as the manufacturing and implantation conditions of said pattern on the deformable surface 4 allow. As such, the pattern of sensitive material is arranged on a rigidified instrumented area 5, in such a way as to limit the influence of the variations of average deformation in the measurements.

Furthermore, each lateral face of a clamp 6, 6a, 6b extends substantially in the radial extension of a raceway 2 in such a way as to obtain together a disposition of the patterns of sensitive material in the vicinity of said clamp and as close as possible to the roller bodies 3.

1-11. (canceled)

12. A roller bearing including a fixed element and a rotating element, each including at least one raceway between which at least one row of roller bodies is arranged in order to allow for the relative rotation of said elements around an axis, the roller bodies being as a support on the raceway of the fixed element by the intermediary of a contact surface, the fixed element including a free surface which is deformable elastically by the forces induced by the passage of the roller bodies during the rotation of the rotating element, said contact surface having at least one instrumented area whereon is associated at least one pattern of a sensitive material which is able to be deformed by delivering a signal that is representative of said deformations, and the instrumented area being delimited axially between:
at first the surface defined by revolution around an axis of the bearing of a straight line passing through the center of one of said roller bodies deforming the surface and by the center of the contact surface of said one roller body; and
a second surface defined by revolution around the axis of the bearing from a normal line to the deformable surface that passes through said center of the contact surface.

13. The roller bearing set forth in claim 12, wherein the at least one pattern of sensitive material is arranged on the instrumented area at a minimum of a thickness of the fixed element, and said thickness being measured according to the normal line to said instrumented area.

14. The roller bearing set forth in claim 12, wherein the at least one pattern of sensitive material is arranged on the instrumented area at a maximum of a rigidity of said instrumented area.

15. The roller bearing set forth in claim 12, wherein the at least one pattern of sensitive material is arranged on the instrumented area at a minimum of a relationship between a thickness of the fixed element and a rigidity of said instrumented area.

16. The roller bearing as set forth in claim 12, wherein the contact surface is defined relatively to a support of one of the roller bodies in a determined load state of said bearing.

17. The roller bearing as set forth in claim 12, wherein the deformable surface forms a flat surface of which the normal line extends radially.

18. The roller bearing as set forth in claim 12, wherein said bearing includes two rows of roller bodies which are arranged respectively between two raceways spaced axially, at least two types of instrumented areas being delimited axially in relation to the roller bodies of respectively one of said rows, the patterns of sensitive materials being arranged on each type of instrumented area so that they deliver a signal that is representative of the deformations induced by the passage of the roller bodies of one row.

19. The roller bearing as set forth in claim 18, wherein the instrumented areas are delimited on a same deformable surface which extends axially.

20. The roller bearing as set forth in claim 12, wherein the fixed element includes at least one clamp that extends radially on its outer periphery, said clamp being adjacent axially to at least one instrumented area in such a way as to ensure rigidification of said area.

21. The roller bearing according to claim 18, wherein a clamp is formed between the rows of roller bodies and the patterns of sensitive material of each type of instrumented areas being arranged axially in the vicinity of respectively one lateral face of the clamp.

22. The roller bearing according to claim 18, wherein the types of instrumented areas are rigidified by respectively a clamp and the patterns of sensitive material of each type of instrumented areas being arranged axially in the vicinity of a lateral face of a clamp.
